(19) United States
(12) Patent Application Publication
(10) Pub. No.: US 2003/0101280 A1
(43) Pub. Date: May 29, 2003

(54) Fast jump address algorithm

(76) Inventor: Kenneth Y. Chiu, San Francisco, CA (US)

Correspondence Address: Rory D. Rankin, Conley, Rose & Tayon, P.C., P.O. Box 398, Austin, TX, 78767, US

(21) Appl. No.: 09/996,510

(22) Filed: Nov. 27, 2001

(51) Int. Cl. G06F 15/16

(52) U.S. Cl. 709/245; 709/227

(57) ABSTRACT

A method and mechanism for reducing data transfer latency. A request for transfer of a block of data is received. In addition, a mask is received which indicates only particular sub-blocks of the block are required. Access to the blocks are made from an interface to a control unit which is configured to transfer data in sub-block units. Each request to the control unit includes an address corresponding to a particular sub-block. In response to receiving a transfer request corresponding to a block of data, the interface is configured to concurrently generate an address corresponding to each sub-block of the block, detect which of the sub-blocks are required as part of said transfer request, and utilize only those generated addresses which correspond to the sub-blocks which are required to generate requests to the control unit. In addition, the interface is configured to determine how many sub-blocks are required by examining the received mask. In response to receiving the required number of sub-blocks from the control unit, the interface detects all required data has been received and no further requests to the control unit are required.

### BACKGROUND OF THE INVENTION

1. Field of the Invention

This invention relates to the field of computer systems and, more particularly, to a method and mechanism for reducing data access latency.

2. Description of the Related Art

Multiprocessing computer systems include two or more processors which may be employed to perform computing tasks. A particular computing task may be performed upon one processor while other processors perform unrelated computing tasks. Alternatively, components of a particular computing task may be distributed among multiple processors to decrease the time required to perform the computing task as a whole.

A popular architecture in commercial multiprocessing computer systems is a shared memory architecture in which multiple processors share a common memory. In shared memory multiprocessing systems, a cache hierarchy is typically implemented between the processors and the shared memory. In order to maintain the shared memory model, in which a particular address stores exactly one data value at any given time, shared memory multiprocessing systems employ cache coherency. Generally speaking, an operation is coherent if the effects of the operation upon data stored at a particular memory address are reflected in each copy of the data within the cache hierarchy. For example, when data stored at a particular memory address is updated, the update may be supplied to the caches which are storing copies of the previous data. Alternatively, the copies of the previous data may be invalidated in the caches such that a subsequent access to the particular memory address causes the updated copy to be transferred from main memory.

Shared memory multiprocessing systems generally employ either a broadcast snooping cache coherency protocol or a directory based cache coherency protocol. In a system employing a snooping broadcast protocol (referred to herein as a “broadcast” protocol), coherence requests are broadcast to all processors (or cache subsystems) and memory through a totally ordered network. By delivering coherence requests in a total order, correct coherence protocol behavior is maintained since all processors and memories make the same decision for each request. When a subsystem having a shared copy of data observes a coherence request for exclusive access to the block, its copy is typically invalidated. Likewise, when a subsystem that currently owns a block of data corresponding to a coherence request, the owning subsystem typically responds by providing the data to the requestor and invalidating its copy, if necessary.

In contrast, systems employing directory based protocols maintain a directory containing information regarding cached copies of data. Rather than unconditionally broadcasting coherence requests, a coherence request is typically conveyed through a point-to-point network to the directory and, depending upon the information contained in the directory, subsequent transactions are sent to those subsystems that may contain cached copies of the data to perform specific coherency actions. For example, the directory may contain information indicating that various subsystems contain shared copies of the data. In response to a coherency request for exclusive access to a block, invalidation transactions may be conveyed to the sharing subsystems. The directory may also contain information indicating subsystems that currently own particular blocks of data. Accordingly, responses to coherency requests may additionally include transactions that cause an owning subsystem to convey data to a requesting subsystem. In some directory based coherency protocols, specifically sequenced invalidation and/or acknowledgment messages are required. Numerous variations of directory based cache coherency protocols are well known.

In certain situations or environments, one device in a system may access the status registers of another device. Frequently, circuitry may be implemented which provides for controlled access to the status registers of a device in order to prevent one device from adversely affecting the operation of another device. However, in some cases, accessing the control registers may result in a relatively significant latency. In modern computing systems where performance is critical, reducing such latencies is of paramount importance.

### SUMMARY OF THE INVENTION

Generally speaking, a method and mechanism for reducing data transfer latency are contemplated. The method comprises receiving a request for transfer of a block of data which comprises a plurality of sub-blocks. Access to the requested data is controlled by a control unit which is not configured to transfer an entire block of data at a time. In one embodiment, the control unit transfers data in sub-block units. While the received transfer request corresponds to a block, fewer than all the sub-blocks of the block may actually be desired or required. In response to receiving the request, addresses for each of the sub-blocks of the block are generated, all of which may be generated concurrently. In response to detecting which of the sub-blocks are actually required, requests to the control unit are limited to only those required sub-blocks utilizing only those generated addresses which correspond to the sub-blocks which are required. In one embodiment, a mask is received with the transfer request which indicates the sub-blocks which are required. In addition, the method and mechanism contemplate determining how many sub-blocks are required and detecting completion in response to receiving the required number of sub-blocks.

### BRIEF DESCRIPTION OF THE DRAWINGS

Other objects and advantages of the invention will become apparent upon reading the following detailed description and upon reference to the accompanying drawings in which:

FIG. 1 is a block diagram of a node.

FIG. 2 is a diagram illustrating one embodiment of a data transfer interface.

FIG. 3 is a diagram of one embodiment of a register file.

FIG. 4 illustrates one embodiment of an addressing scheme.

FIG. 5 illustrates one embodiment of a byte mask.

FIG. 6 shows one embodiment of a method for reducing transfer latency.

FIG. 7 is a block diagram of one embodiment of an interface.

FIG. 8 is a diagram illustrating one embodiment of a detect circuit.

FIG. 9 is a diagram illustrating one embodiment of a control circuit.

FIG. 10 illustrates one embodiment of the operation of a method for reducing latency.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Node Overview

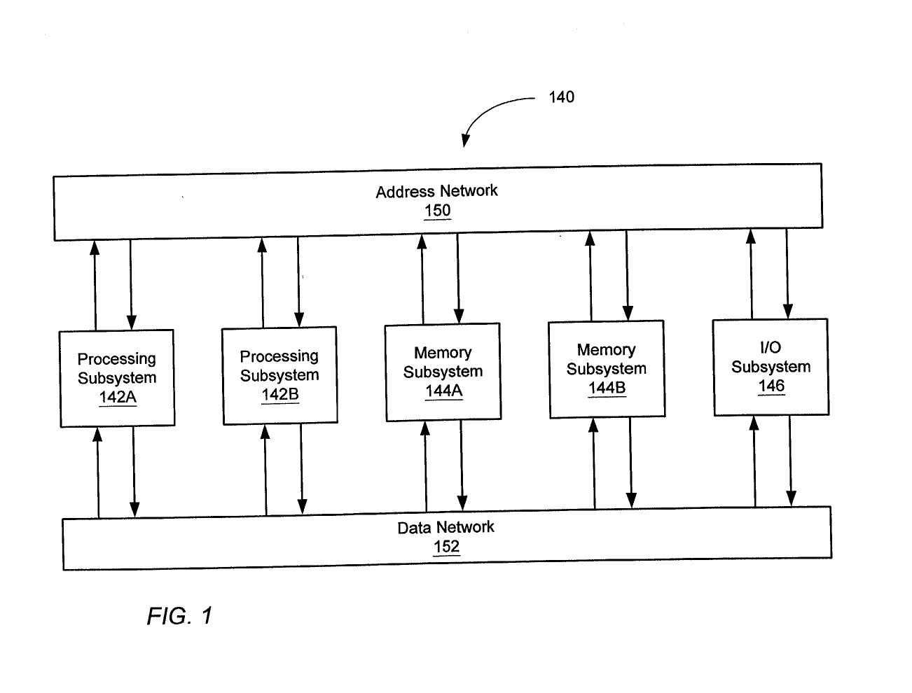

FIG. 1 is a block diagram of one embodiment of a computer system 140. Computer system 140 includes processing subsystems 142A and 142B, memory subsystems 144A and 144B, and an I/O subsystem 146 interconnected through an address network 150 and a data network 152. Computer system 140 may be referred to as a “node”. As used herein, the term “node” refers to a group of clients which share common address and data networks. In the embodiment of FIG. 1, each of processing subsystems 142, memory subsystems 144, and I/O subsystem 146 may be considered a client, or device. It is noted that, although five clients are shown in FIG. 1, embodiments of computer system 140 employing any number of clients are contemplated. Elements referred to herein with a particular reference number followed by a letter will be collectively referred to by the reference number alone. For example, processing subsystems 142A-142B will be collectively referred to as processing subsystems 142.

Generally speaking, each of processing subsystems 142 and I/O subsystem 146 may access memory subsystems 144. Each client in FIG. 1 may be configured to convey address transactions on address network 150 and data on data network 152 using split-transaction packets. Typically, processing subsystems 142 include one or more instruction and data caches which may be configured in any of a variety of specific cache arrangements. For example, set-associative or direct-mapped configurations may be employed by the caches within processing subsystems 142. Because each of processing subsystems 142 within node 140 may access data in memory subsystems 144, potentially caching the data, coherency must be maintained between processing subsystems 142 and memory subsystems 144, as will be discussed further below.

Memory subsystems 144 are configured to store data and instruction code for use by processing subsystems 142 and I/O subsystem 146. Memory subsystems 144 preferably comprise dynamic random access memory (DRAM), although other types of memory may be used. Each address in the address space of node 140 may be assigned to a particular memory subsystem 144, referred to as the home subsystem of the address. Further, each memory subsystem 144 may include a directory suitable for implementing a directory-based coherency protocol. In one embodiment, each directory may be configured to track the states of memory locations assigned to that memory subsystem within node 140. For example, the directory of each memory subsystem 144 may include information indicating which client in node 140 currently owns a particular portion, or block, of memory and/or which clients may currently share a particular memory block. Additional details regarding suitable directory implementations will be discussed further below.

In the embodiment shown, data network 152 is a point-to-point network. However, it is noted that in alternative embodiments other networks may be used. In a point-to-point network, individual connections exist between each client within the node 140. A particular client communicates directly with a second client via a dedicated link. To communicate with a third client, the particular client utilizes a different link than the one used to communicate with the second client.

Address network 150 accommodates communication between processing subsystems 142, memory subsystems 144, and I/O subsystem 146. Operations upon address network 150 may generally be referred to as address transactions. When a source or destination of an address transaction is a storage location within a memory subsystem 144, the source or destination is specified via an address conveyed with the transaction upon address network 150. Subsequently, data corresponding to the transaction on the address network 150 may be conveyed upon data network 152. Typical address transactions correspond to read or write operations. A read operation causes transfer of data from a source outside of the initiator to a destination within the initiator. Conversely, a write operation causes transfer of data from a source within the initiator to a destination outside of the initiator. In the computer system shown in FIG. 1, a read or write operation may include one or more transactions upon address network 150 and data network 152.

In one embodiment, processing subsystem 142A includes status registers which indicate the operational status of subsystem 142A. These status registers may also be operable to configure various features of subsystem 142A, or otherwise affect the operation of subsystem 142A. In one embodiment, processing subsystem 142B may access the status registers of subsystem 142A by issuing read and/or write transactions. Generally speaking, during a read transaction, subsystem 142B may issue an address transaction upon address network 150 which indicates the register, or registers, to be read. Subsequently, data corresponding to the registers is returned via the data network 152. When performing a write transaction to status registers within subsystem 142A, subsystem 142B may first issue an address transaction upon address network 150, followed by write data upon data network 152.

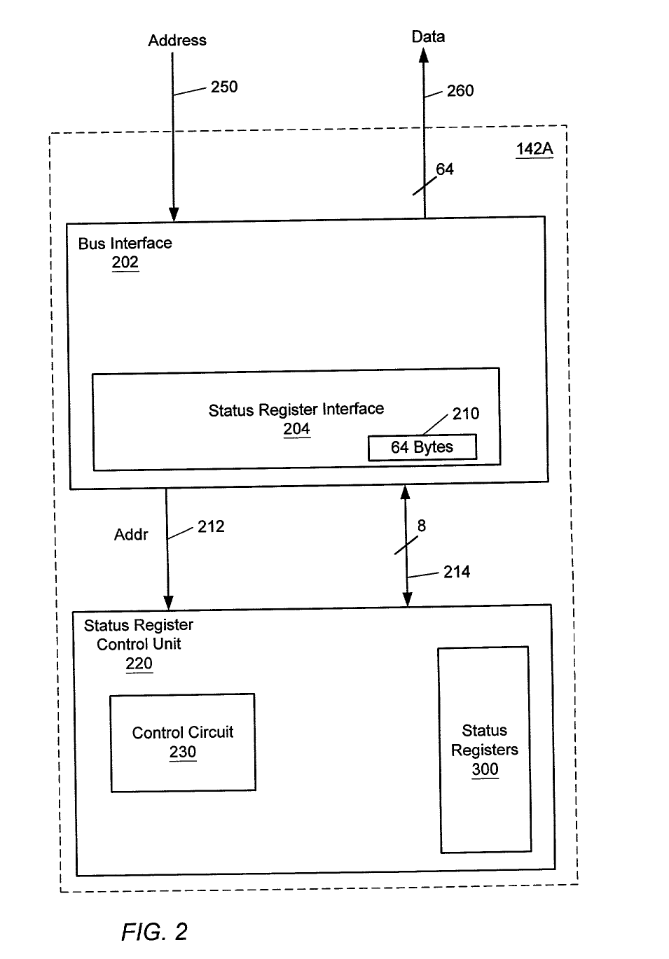

Turning now to FIG. 2, one embodiment of a processing subsystem 142A is shown. It is to be understood that processing subsystem 142A is intended to be exemplary only. The method and mechanism described in the following discussion may be used in a wide variety of devices and systems. Those skilled in the art will appreciate its wide applicability.

Included in the embodiment of FIG. 2, are a bus interface 202 and status register control unit 220. Generally speaking, bus interface 202 is configured to provide an interface to address network 150 and data network 152. Status register control unit 220 is configured to control accesses to status registers 300. Bus interface 202 includes a status register interface 204 which is configured to communicate with control unit 220. Also shown are status registers 300 and a data buffer 210. While buffer 210 is shown within interface 204, and status register 330 are shown within control unit 220, this need not be the case.

During operation, bus interface 202 may receive a request (RIO) to read from status registers 300. In response to the read request, status register interface 204 may convey signals to status register control unit 220 indicating the request. In one embodiment, status register interface conveys an address to control unit 220 which corresponds to the register to be read. Any of a number of suitable communication protocols may be employed between status register interface 204 and control unit 220. For example, status register interface 204 may assert a request signal to control unit 220 which subsequently asserts a grant. In response to a read request, control circuit 230 may then access the corresponding register 300 and convey the register data via bus 214. Similar to the above, status register interface 204 may receive a request to write (WIO) to one or more of registers 300. In response to the request, the status register interface 204 conveys a corresponding request to control unit 220.

In one embodiment, data transferred in response to read or write accesses to status registers 300 convey more data than can be conveyed upon data bus 214 at one time. For example, in one embodiment, in response to an RIO request, 64 Bytes of data are returned to the requester. Similarly, 64 Bytes of data may be conveyed along with a WIO request. In such an embodiment, the address which accompanies the read or write request may be on a 64 Byte boundary. However, data bus 214 may be configured to convey only 8 Bytes of data at a time. Consequently, eight transfers of data between status register interface 204 and control unit 220 are required to fulfill a 64 Byte request. Still further, status register interface 204 may be required to request access via control unit 220 eight separate times, calculating and conveying a separate address each time, in order to complete the request. Data being transferred to, or received from, control unit 220, may be temporarily buffered within a 64 Byte data buffer 210 until the data transfer is complete. Consequently, reads and writes to status registers 300 may entail a relatively significant latency. In addition to the above, a status register read or write request may in fact seek access to fewer than all of the 64 Bytes. For example, a read or write request may be accompanied by a mask indicating which registers (groups of eight bytes) are actually required. If the transfer actually requires fewer than all 64 bytes, performing eight transfers to meet the 64 Byte request involves needless delay.

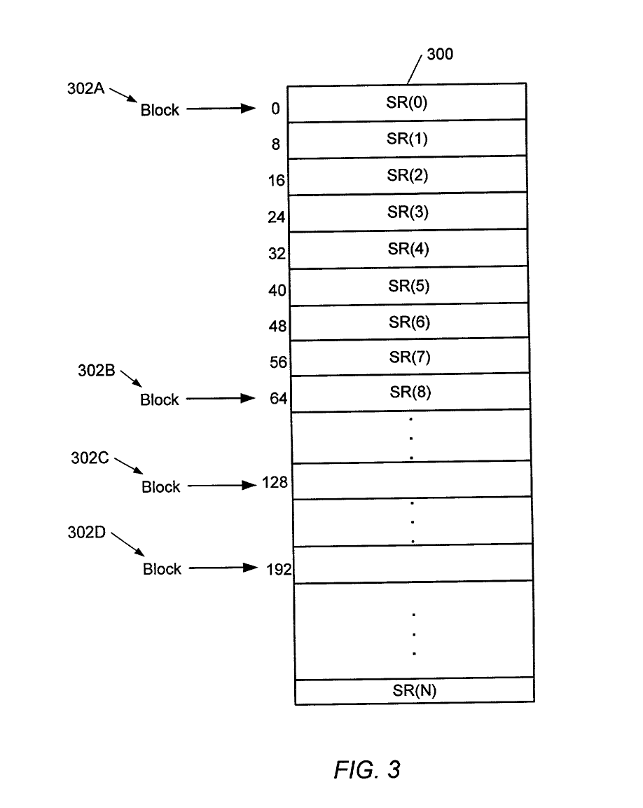

FIG. 3 illustrates one embodiment of registers 300. In one embodiment, each addressable status register included in registers 300 includes 8 Bytes of data. Therefore, each block of 64 Bytes includes eight status registers. In the above described embodiment, each read or write access corresponds to 64 Bytes of data and may include an address on a 64 Byte boundary. Consequently, status registers 300 may be viewed as comprising 64 Byte blocks of data. A first block 302A may have an offset address of 0, a second block 302B may have an offset address of 64, a third block 302C may have an offset of 128, a fourth block 302D may have an offset of 192, and so on. In the example shown, the first block 302A includes the eight status registers SR(0)-SR(7). So, for example, a read request for status register SR(4) may include an address with offset 0, and a byte mask indicating the fifth group of eight bytes within the corresponding block are required.

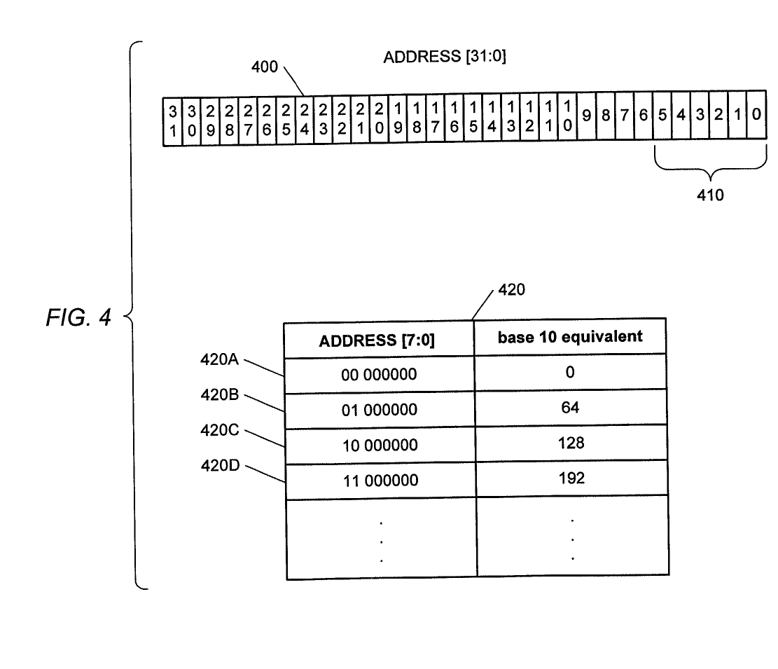

FIG. 4 illustrates one embodiment of an addressing scheme wherein status registers access requests include addresses on a 64 Byte boundary. In the embodiment of FIG. 4, an address 400 comprises 32 bits. Other embodiment may include more or fewer bits. Status register access requests which occur on 64 Byte boundaries may have the six least significant bits 410 equal to zero. Table 420 illustrates a few examples 420 of such addresses. The first example 420A corresponds to an offset of 0, the second corresponds to an offset of 64, the third corresponds to an offset of 128, the fourth corresponds to an offset of 192, and so on. As previously mentioned, a status register access request may be accompanied by a byte mask which indicates the group of eight bytes of interest.

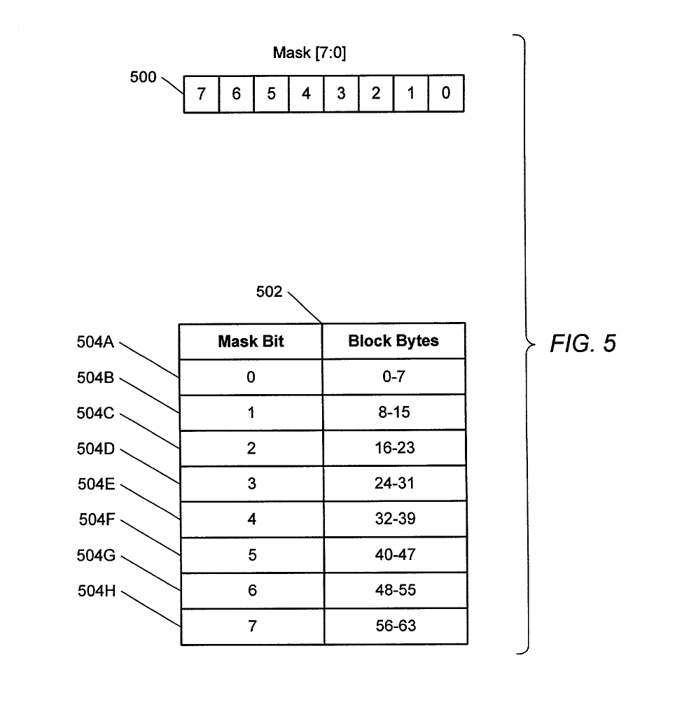

FIG. 5 illustrates one example of a byte mask 500. In the embodiment shown, byte mask 500 includes eight bits. Each bit corresponds to a group of eight bytes of data within a 64 byte block of data. For example, table 502 of FIG. 5 illustrates one correspondence between bits of mask 500 and bytes of data within a block. Bit 0 corresponds to bytes 0-7 within a given block, bit 1 corresponds to bytes 8-15, etc. In this manner, byte mask 500 may be used to correspond to a 64 byte block of data. In one embodiment, a bit with a first value (e.g., “1”) in the mask 500 indicates the corresponding eight bytes are required. A bit with a second value (e.g., “0”) may be used to indicate the corresponding data bytes are not required. Of course, other embodiments may include more or fewer bits. Further, in other embodiments, each bit may correspond to other than eight bytes of data.

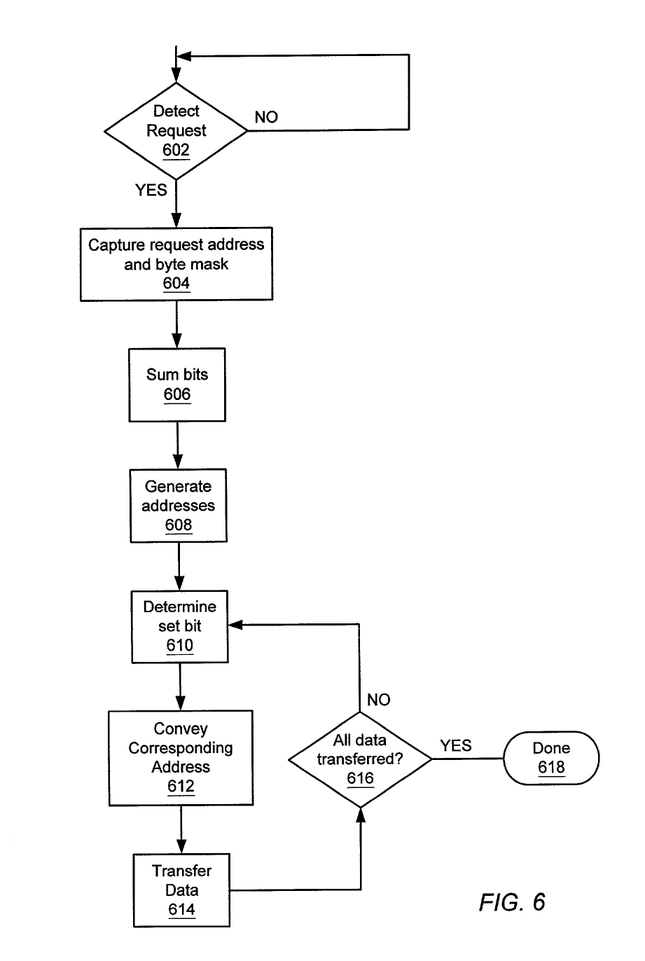

Turning now to FIG. 6, one embodiment of a method for reducing the latency of status register accesses is shown. Generally speaking, the method contemplates reducing the required number of transfers between the status register interface 204 and the status register control unit 220 in order to fulfill an access request. In response to detecting a request for access to the status registers (block 602), the address corresponding to the request and the byte mask are captured (block 604). The number of bits which are set in the byte mask are then summed (block 606) to determine the number of registers (eight bytes each) which are required within the block. Also, eight addresses are generated (block 608), each of which addresses one of the eight registers within the block which is addressed by the request. A determination is then made as to which is the first bit in the mask which is set (block 610). Subsequent to determining this bit (block 610), the generated address which corresponds to this bit position is utilized and conveyed (block 612) to the status register control unit 220. Corresponding data is then transferred (block 614) between the interface 204 and control unit 220. If all the required data have been transferred (block 616) to the status register interface 204, then no further accesses to the status register control unit 220 are required for the current transfer (block 618). If the required data still remains to be transferred, control returns to block 610. In one embodiment, bits of the mask are “masked off” after they have already been considered. Subsequent determinations (block 610) then only consider the remaining bits of the mask.

In the case of a read access, data may be transferred from the control unit to the interface 204. Conversely, in the case of a write access, data may be transferred from the interface 204 to the control unit 220. In response to detecting the transfer of the data, the status register interface 204 determines whether all the desired data has been transferred. In one embodiment, this determination is made by comparing the number of data transfers completed to the bit sum which was previously calculated (block 606). If all the desired data has been transferred, the transfer is done (block 618). Otherwise, the next bit which is set may be determined (block 610) and further transfers may be initiated.

Utilizing the above method, the number of transfers between interface 204 and control unit 220 may be reduced to the number of desired registers. Consequently, if only three bits of the byte mask are set, the number of transfers may be reduced from eight to three and overall latency may be reduced.

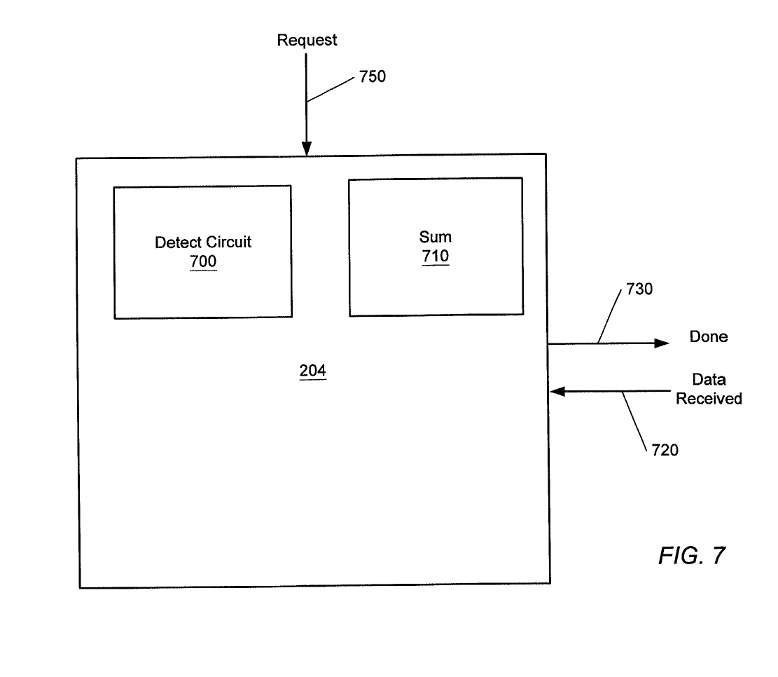

FIG. 7 illustrates a block diagram of one embodiment of status register interface 202 configured to reduce status register access latency. Interface 202 is coupled to receive a status register access request 750 which may include both an address and byte mask. Interface 202 includes a detect circuit 700 and a sum circuit 710. Interface 202 is further configured to convey a done signal 730 and receive a data transfer indication 720. Detect circuit 700 is configured to perform address generation and detect set bits within a received byte mask. Sum circuit 710 is configured to determine a number of set bits within the received byte mask.

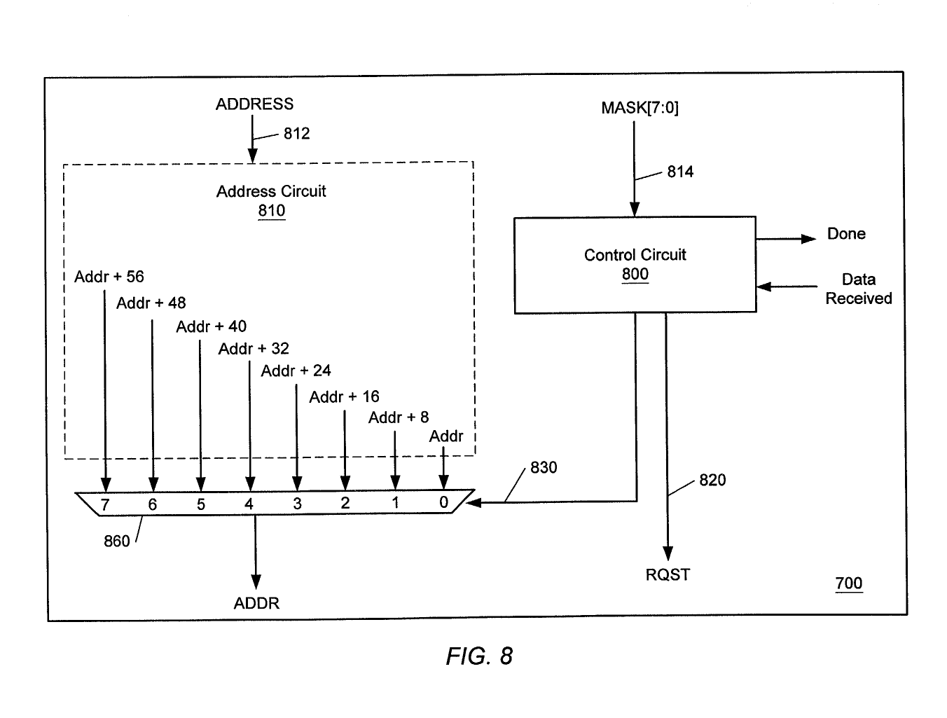

FIG. 8 illustrates a portion of one embodiment of detect circuit 700. Included in FIG. 8 is an address circuit 810 and control circuit 800. Address circuit 810 is coupled to receive an address 812 corresponding to a status register access request. Control circuit 800 is coupled to receive a byte mask 814 corresponding to a status register access request. Address circuit is configured to generate eight addresses which are then conveyed to multiplexor 860. In one embodiment, the received address 812 corresponds to a 64 byte boundary. Address circuit is configured to generate an address corresponding to each group of eight bytes with a 64 byte block. In the above described embodiment wherein each status register comprises eight bytes, address circuit 810 generates an address corresponding to each register within the block addressed by the received address 810. In one embodiment, address circuit 810 generates each address in parallel by setting a least significant bits of the received address to a predetermined value. For example, a first address, Addr, may address the first register within the block and may simply equal the received address 812. A second address, Addr+8, generated may address the second register in the block and may correspond to the received address with the least significant bits set to an offset of 8. The third may have an offset of 16, the fourth an offset of 24, and so on. In this manner, eight addresses are concurrently generated, each of which address one of the eight registers within the 64 byte block.

It is understood that various types of address translation may be employed. Further, rather than the status register file being byte addressable wherein each successive register address differs by an address of eight, the registers may be addressable in other units and the address adjusted accordingly. For example, if the status registers were addressable in unit of eight bytes and a first register were addressed with an offset of 0, the second register may be addressed with an offset of 1. Numerous variations are possible and are contemplated.

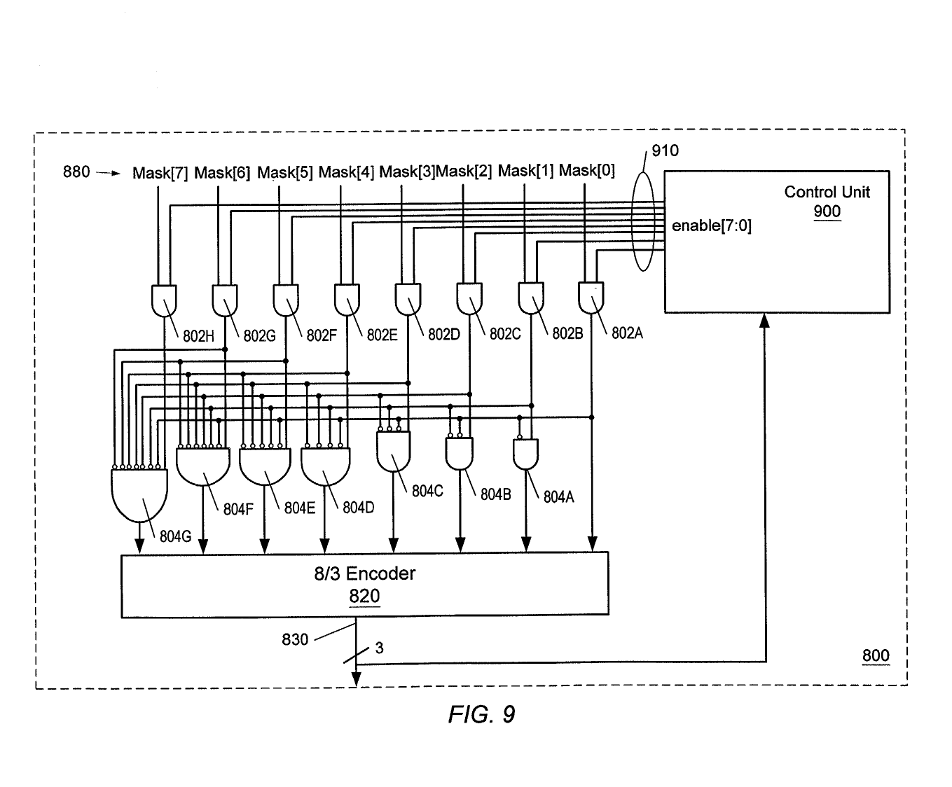

Control circuit 800 is configured to convey a signal 830 to multiplexor 860 in order select one of the generated addresses for conveyance to the status register control unit 220. In addition, in one embodiment, control circuit 800 may be configured to generate a request signal 820 for conveyance to status register control unit 220 as part of a communication protocol. FIG. 9 illustrates a portion of one embodiment of control circuit 800. Control circuit 800 includes control unit 900, encoder 820, and logic gates 802 and 804. Circuit 800 is configured to detect bits which are set within byte mask 880 and convey a corresponding signal 830 for conveyance to multiplexor 860. The portion of circuit 800 shown in FIG. 9 is configured such that no more than one signal entering encoder 820 is set at a time. Each of AND gates 802 are coupled to a bit of the received byte mask 880 which corresponds to a status register access request. In addition, each of gates 802 is coupled to an enable signal 910 conveyed from control unit 900.

Initially, control unit 900 is configured to provide a set enable signal (i.e. a binary “1” in this case) to all gates 802. In this manner, each gate 802 will convey the received bit of byte mask 880, whatever the value of that bit. Output from each of gates 802B-802H is coupled to a corresponding gate 804A-804G, respectively. In addition, output from each of gates 802A-802G is also coupled to all of gates 804 via inverted input which are of a higher bit number, gates 804A-804G, respectively. Consequently, if a particular gate 802 conveys a logic “1”, all of gates 804 which are of a higher bit number will be effectively turned off and will convey a “0”. Therefore, only one of gates 802A, or 804 will convey a logic “1” at a time. Upon receiving the signals from gates 802A, and 804, encoder 820 determined which of the eight bits is set and encodes a corresponding three bit value for conveyance 830. In one embodiment, encoder 820 comprises an 8-to-3 encoder. However, any suitable circuitry may be employed. Signal 830 is then conveyed to multiplexor 880 for gating out the corresponding address.

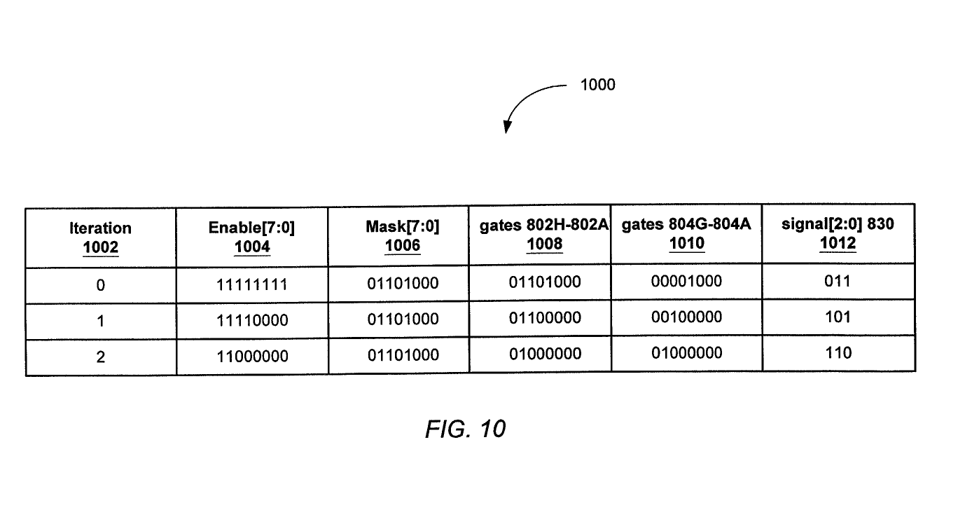

In addition, signal 830 is conveyed to control unit 900. Control unit 900 determines the value of signal 830, and sets the enable signals 910 for the next transfer request based in part on this determination. Subsequent enable signals are only set for mask bits 880 with a higher bit number position than the value of the received signal 830. In this manner, the enable signals 910 are used to mask off all lower bit values which have been considered. FIG. 10 shows one embodiment of an example of this process. FIG. 10 includes a table 1000 which illustrates a sequence of values which may occur. Table 1000 includes six columns. Column 1002 indicates a particular iteration, column 1004 indicates enable bits conveyed by control unit 900, column 1006 indicates byte mask bits, column 1008 indicates values conveyed from gates 802H-802A, column 101 indicates values conveyed from gates 804G-804A, and column 1012 indicates the three bit value 830 conveyed by encoder 820.

Assuming a request has been received, iteration 0 indicates resulting values. In the example shown, the received byte mask 1006 has a value of “01101000”. Therefore, only bits 6, 5, and 3 are set in the byte mask. Initially, control unit 900 conveys enable[7:0] signals which are all set “11111111”. Setting all enable bits initially allows all mask bits to be checked. With all enable bits set, gates 802 gate out the value of the mask bits “01101000” 1008. Because gate 802D is set, gates 804G-804D convey a value of “0”, while gate 804C conveys a “1”. Therefore encoder 820 receives the value “00001000”. Encoder 820 detects that bit 3 is set and conveys a corresponding value of “011”. Subsequently at iteration 1, control unit 900 masks off all enables bits equal to bit position “011” and below. Consequently, the new enable bits are “11110000”. In this case, only the upper four bits of the byte mask are gated out by gates 802. Bit 5 is detected as being set and encoder subsequently conveys the value “101”. At iteration 2, control unit 900 masks off all bits positions of the enable bits with a position equal to 5 or lower. Consequently, the new enable bits are “11000000”. Therefore, only bits [7:6] of the byte mask are conveyed by gates 802. Bit 6 is detected as being set, and encoder 820 conveys the value “110”. Using the above described embodiment, only three transfers are required and access latency is reduced.

Numerous variations and modifications will become apparent to those skilled in the art once the above disclosure is fully appreciated. For example, while the above examples utilize AND gates and set bits equal to a binary “1”, many other possible implementations and alternatives are possible and are contemplated. Additionally, those skilled in the art will appreciate the applicability to the above described embodiments to any comparable transfers of data between devices or entities.

It is intended that the following claims be interpreted to embrace all such variations and modifications.

What is claimed is:

1. A method for fast address calculation comprising:
receiving a transfer request corresponding to a block of data, wherein said block comprises a plurality of sub-blocks;
generating an address corresponding to each of said sub-blocks;
detecting which of said sub-blocks are required as part of said transfer request; and
utilizing only those generated addresses which correspond to the sub-blocks which are required.

2. The method of claim 1, further comprising receiving a mask which corresponds to the request, wherein the mask indicates which of said sub-blocks are required as part of the request, and wherein detecting which of said sub-blocks are required comprises examining said mask.

3. The method of claim 2, wherein said mask comprises a bit corresponding to each of said sub-blocks, wherein a bit with a first value indicates said corresponding sub-block is required, and wherein a bit with a second value indicates said corresponding sub-block is not required.

4. The method of claim 1, wherein said request includes an address corresponding to said block, and wherein said transfer comprises transferring one of said sub-blocks at a time.

5. The method of claim 1, wherein each of said addresses corresponding to said sub-blocks are generated concurrently.

6. The method of claim 3, wherein said detecting comprises:
detecting a first bit of said mask which has a first value, wherein said first bit corresponds to a first sub-block; and
selecting a first address of said generated addresses which corresponds to the first sub-block.

7. The method of claim 6, wherein said detecting further comprises:
masking off said first bit of said mask, subsequent to utilizing said first address;
detecting a second bit of said mask which has a first value, wherein said second bit corresponds to a second sub-block; and
selecting a second address of said generated addresses which corresponds to the second sub-block.

8. The method of claim 1, further comprising:
determining a first number of said sub-blocks are required; and
detecting transfer of all said required sub-blocks are complete, in response to detecting a number of sub-blocks equal to said first number have been transferred.

9. A device for reducing data transfer latency comprising:
a first interface configured to receive a transfer request, wherein said request corresponds to a block of data comprising a plurality of sub-blocks;
a second interface, wherein said second interface is configured to:
generate an address corresponding to each of said sub-blocks;
detect which of said sub-blocks are required as part of said transfer request; and
utilize only those generated addresses which correspond to the sub-blocks which are required.

10. The device of claim 9, wherein said first interface is further configured to receive a mask corresponding to the request, wherein the mask indicates which of said sub-blocks are required as part of the request, and wherein said second interface is further configured to detect which of said sub-blocks are required by examining said mask.

11. The device of claim 10, wherein said mask comprises a bit corresponding to each of said sub-blocks, wherein a bit with a first value indicates said corresponding sub-block is required, and wherein a bit with a second value indicates said corresponding sub-block is not required.

12. The device of claim 9, wherein said request includes an address corresponding to said block, and wherein said second interface is configured to initiate transfer of only one of said sub-blocks at a time.

13. The device of claim 9, wherein said second interface is configured to generate each of said addresses corresponding to said sub-blocks concurrently.

14. The device of claim 11, wherein said second interface is configured to detect which of said sub-blocks are required by:
detecting a first bit of said mask which has a first value, wherein said first bit corresponds to a first sub-block; and
selecting a first address of said generated addresses which corresponds to the first sub-block.

15. The device of claim 14, wherein said second interface is further configured to detect said required sub-blocks by:
masking off said first bit of said mask, subsequent to utilizing said first address;
detecting a second bit of said mask which has a first value, wherein said second bit corresponds to a second sub-block; and
selecting a second address of said generated addresses which corresponds to the second sub-block.

16. The device of claim 9, wherein said second interface is further configured to:
determine a first number of said sub-blocks are required; and
detect transfer of all said required sub-blocks are complete, in response to detecting a number of sub-blocks equal to said first number have been transferred.

17. A system comprising:
a control unit, wherein said control unit is configured to control access to a plurality of blocks of data, wherein each of said blocks of data comprise a plurality of sub-blocks, and wherein said control unit is not configured to convey a full block of said blocks of data at one time;
a first interface coupled to said control unit, wherein said interface is configured to:
receive a transfer request, wherein said request corresponds to a first block of said blocks of data;
generate an address corresponding to each sub-block of said first block;
detect which of said sub-blocks are required as part of said transfer request; and
utilize only those generated addresses which correspond to the sub-blocks which are required.

18. The system of claim 17, wherein said first interface is further configured to:
receive a mask corresponding to said request, wherein the mask indicates which of said sub-blocks are required as part of the request; and
detect which of said sub-blocks are required by examining said mask.

19. The system of claim 18, wherein said mask comprises a plurality of bits, each of which correspond to a sub-block of said first block, wherein a bit with a first value indicates said corresponding sub-block is required, and wherein a bit with a second value indicates said corresponding sub-block is not required.

20. The system of claim 17, wherein said first interface is configured to generate each of said addresses corresponding to said sub-blocks concurrently.

21. The system of claim 19, wherein said first interface is configured to detect which of said sub-blocks are required by:
detecting a first bit of said mask which has a first value, wherein said first bit corresponds to a first sub-block; and
selecting a first address of said generated addresses which corresponds to the first sub-block.

22. The system of claim 21, wherein said first interface is further configured to:
mask off said first bit of said mask, subsequent to utilizing said first address;
detect a second bit of said mask which has a first value, wherein said second bit corresponds to a second sub-block; and
select a second address of said generated addresses which corresponds to the second sub-block.

23. The system of claim 17, wherein said first interface is further configured to:
determine a first number of said sub-blocks are required; and
detect transfer of all said required sub-blocks are complete, in response to detecting a number of sub-blocks equal to said first number have been transferred.
